(19) United States
(12) Patent Application Publication
(10) Pub. No.: US 2024/0317217 A1
(43) Pub. Date: Sep. 26, 2024

(54) AUTONOMOUS DRIVING CONTROL APPARATUS AND METHOD THEREOF

(71) Applicants: Hyundai Motor Company, Seoul (KR); Kia Corporation, Seoul (KR)

(72) Inventors: Su Young Choi, Seoul (KR); Kyung Won Kang, Seoul (KR); Hae Ryong Lee, Seoul (KR); Jeong Soo Kim, Seoul (KR)

(21) Appl. No.: 18/520,026

(22) Filed: Nov. 27, 2023

(30) Foreign Application Priority Data
Mar. 21, 2023 (KR) 10-2023-0036847

(51) Int. Cl. B60W 30/09; B60W 30/095; B60W 30/18; B60W 40/105; B60W 60/00

(52) U.S. Cl. CPC B60W 30/09; B60W 30/0956; B60W 30/18159; B60W 40/105; B60W 60/0015; B60W 2554/20; B60W 2556/40

(57) ABSTRACT

An autonomous driving control apparatus for controlling an autonomous vehicle to travel by avoiding a static object located on a driving path and a method thereof. The autonomous driving control apparatus may include a memory storing map data including road information, a sensor configured to detect an object, and a processor coupled to the memory and the sensor. The processor may be configured to determine, using the sensor, a static object located in an exit section of an intersection associated with a vehicle, determines a drivable area, based on a location of the static object and the road information included in the map data, determine, based on the drivable area, a driving path for the vehicle to avoid a collision with the static object, and control a movement of the vehicle along the driving path.

### CROSS-REFERENCE TO RELATED APPLICATION

This application claims the benefit of priority to Korean Patent Application No. 10-2023-0036847, filed in the Korean Intellectual Property Office on Mar. 21, 2023, the entire content of which is incorporated herein by reference.

### TECHNICAL FIELD

The present disclosure relates to an autonomous driving control apparatus for controlling an autonomous vehicle to travel by avoiding a static object located on a driving path and a method thereof.

### BACKGROUND

An autonomous vehicle may recognize driving environments without manipulation by its driver to determine a risk and may plan a driving path to drive itself. The autonomous vehicle plans a driving path under various driving situations, for example, making a right turn at an intersection, making a right turn, avoiding an object, and the like. When the autonomous vehicle is driving through an intersection along a previously planned path and locates a vehicle that is parked or stopped at an exit section of the intersection, the autonomous vehicle may need to plan a new driving path by avoiding the parked or stopped vehicle after stopping behind the parked or stopped vehicle and making a lane change. Thus, when the autonomous vehicle travels by avoiding the parked or stopped vehicle, the behavior of the vehicle can be unnatural and inefficient.

### SUMMARY

The present disclosure addresses the above-mentioned problems occurring in the prior art while advantages achieved by the prior art are maintained intact.

An aspect of the present disclosure provides an autonomous driving control apparatus for planning a path such that a vehicle travels by avoiding (e.g., avoiding a collision with) a static object located on a driving path of the vehicle during autonomous driving and a method thereof.

Another aspect of the present disclosure provides an autonomous driving control apparatus for planning a path to avoid a static object without executing a lane change function, when there is the static object in an exit section (or a right-turn section) of the intersection during autonomous driving and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an autonomous driving control apparatus may include: a memory storing map data comprising road information; a sensor configured to detect an object; and a processor coupled to the memory and the sensor. The processor may be configured to: determine, using the sensor, a static object located in an exit section of an intersection associated with a vehicle; determine, based on a location of the static object and the road information included in the map data, a drivable area; determine, based on the drivable area, a driving path for the vehicle to avoid a collision with the static object; and control a movement of the vehicle along the driving path.

The processor may be configured to determine the static object by determining, based on a moving speed of the object detected by the sensor and based on the road information, that the object detected by the sensor is the static object.

The processor may be configured to determine the drivable area by excluding the location of the static object from a lane on which the vehicle is traveling and from an adjacent lane that is next to the lane on which the vehicle is traveling.

The processor may be further configured to: determine, in the drivable area, a reference path; determine a portion of the reference path in an optimization target section; and optimize the portion of the reference path in the optimization target section.

The processor may be further configured to: determine a control target point on a current driving path of the vehicle; determine, based on information about the static object and based on the map data, an entry target lane section; determine whether a straight line connecting the control target point and one point of the entry target lane section intersects a boundary of the drivable area; and based on a determination that the straight line does not intersect the boundary of the drivable area, determine an intersection point of straight lines that are generated based on headings at the control target point and the one point of the entry target lane section. The reference path may be determined based on the control target point, the one point of the entry target lane section, and the intersection point.

The processor may be configured to determine the reference path based on a quadratic Bezier curve.

The processor may be configured to optimize the portion of the reference path in the optimization target section based on a quadratic programming optimization scheme.

The processor may be configured to optimize the portion of the reference path in the optimization target section based on a collision determination condition and a curvature limit condition.

The collision determination condition may be defined such that an optimization path does not deviate from a boundary of the optimization path.

The curvature limit condition may be defined such that a curvature radius for each optimization path point is greater than a minimum turning radius of the vehicle.

According to one or more example embodiments of the present disclosure, an autonomous driving control method may include: detecting, using a sensor, a static object located in an exit section of an intersection associated with a vehicle; determining, based on a location of the static object and based on road information included in map data stored in a memory, a drivable area; generating, based on the drivable area, a driving path for the vehicle to avoid a collision with the static object; and controlling a movement of the vehicle along the driving path.

Detecting the static object may include: determining, based on a moving speed of the object detected by the sensor and based on the road information, that the object detected by the sensor is the static object.

Determining the drivable area may include: excluding the location of the static object from a lane on which the vehicle is traveling and from an adjacent lane that is next to the lane on which the vehicle is traveling.

Generating the driving path may include: determining, in the drivable area, a reference path; determining a portion of the reference path in an optimization target section; and optimizing the portion of the reference path in the optimization target section.

Generating the reference path may include: determining a control target point on a current driving path of the vehicle; determining, based on information about the static object and further based on the map data, an entry target lane section; determining whether a straight line connecting the control target point and one point of the entry target lane section intersects a boundary of the drivable area; and, based on a determination that the straight line does not intersect the boundary of the drivable area, determining an intersection point of straight lines that are generated based on headings at the control target point and the one point of the entry target lane section. The reference path may be determined based on the control target point, the one point of the entry target lane section, and the intersection point.

Generating the reference path may include: determining the reference path based on a quadratic Bezier curve.

Optimizing may include: optimizing the portion of the reference path in the optimization target section using a quadratic programming optimization scheme.

Optimizing may include: optimizing the portion of the reference path in the optimization target section based on a collision determination condition and a curvature limit condition.

The collision determination condition may be defined such that an optimization path does not deviate from a boundary of the optimization path.

The curvature limit condition may be defined such that a curvature radius for each optimization path point is greater than a minimum turning radius of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an autonomous driving control apparatus;

FIG. 2 is a drawing for describing a method for selecting a drivable area;

FIG. 3 is a flowchart illustrating an autonomous driving control method;

FIG. 4 is a flowchart illustrating a process of generating a path;

FIGS. 5, 6, 7, 8, and 9 are drawings illustrating a process of generating a reference path;

FIGS. 10 and 11 are drawings illustrating an example of generating a reference path;

FIG. 12 is a drawing for describing a method for extracting an optimization target section;

FIG. 13 is a drawing illustrating a quadratic programming (QP) optimization result; and

FIG. 14 is a drawing illustrating real-vehicle test and simulation results.

### DETAILED DESCRIPTION

Hereinafter, one or more example embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the one or more example embodiments according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this invention belongs. It will be understood that terms used herein should be interpreted as having a meaning that is consistent with their meaning in the context of this disclosure and the relevant art and will not be interpreted in an idealized or overly formal sense unless expressly so defined herein.

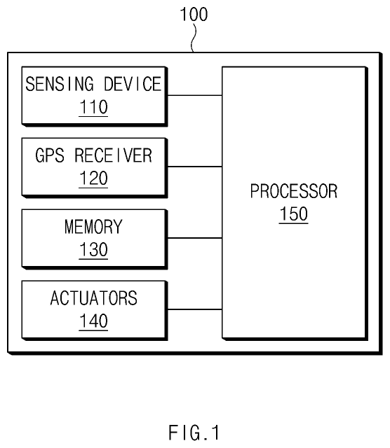

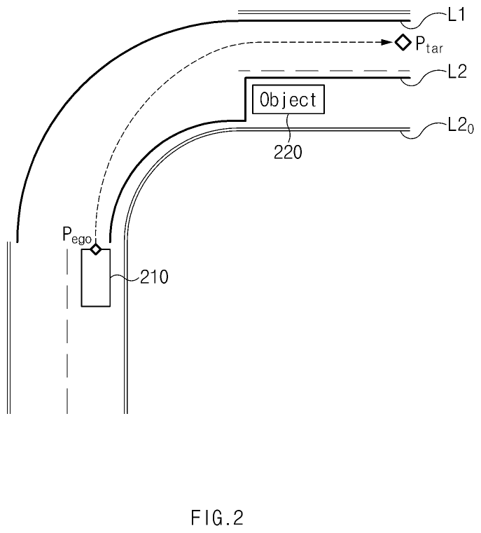

FIG. 1 is a block diagram illustrating a configuration of an autonomous driving control apparatus. FIG. 2 is a drawing for describing a method for selecting a drivable area.

An autonomous driving control apparatus 100 may be mounted on a vehicle loaded with an autonomous driving function. The autonomous driving control apparatus 100 may include a sensing device 110, a global positioning system (GPS) receiver 120, a memory 130, actuators 140, and a processor 150.

The sensing device 110 may obtain information about an object (e.g., another vehicle, a bicycle, a mobility, and/or a motorcycle, and/or the like) located around the vehicle using at least one sensor mounted on the vehicle. The at least one sensor may include a camera, radio detecting and ranging (radar), light detection and ranging LiDAR, an ultrasonic sensor, and/or the like.

The sensing device 110 may obtain environmental information around the vehicle using the at least one sensor mounted on the vehicle. The environmental information may include a road state (e.g., a congested state, a smooth state, a state of being under construction, and the like), whether an accident occurs, and/or the like. Furthermore, the sensing device 110 may extract road information from map data stored in the memory 130.

The sensing device 110 may obtain vehicle behavior information using a wheel speed sensor, a steering angle sensor, an inertial measurement unit (IMU), and/or the like. The vehicle behavior information may include a vehicle speed, a steering angle, a vehicle attitude, and/or the like.

The GPS receiver 120 may receive a signal transmitted from a satellite and may calculate a current position of the vehicle (or a vehicle position) using the received signal. The GPS receiver 120 may calculate a distance between the satellite and the GPS receiver 120 using a time difference between a time when the satellite transmits a signal and a time when the GPS receiver 120 receives the signal. The GPS receiver 120 may calculate the current position of the vehicle using the calculated distance between the satellite and the GPS receiver 120 and position information of the satellite, which is included in the transmitted signal. At this time, the GPS receiver 120 may calculate the current position using triangulation.

A high-definition map database (DB) may be implemented in the memory 130. The high-definition map DB (or high-definition map data) may be updated by high-definition map data received in real time through a communication device (not shown) such as a transceiver.

The memory 130 may store a path plan algorithm (or path generation logic), autonomous driving control logic, various pieces of setting information, and/or the like. The memory 130 may be a non-transitory storage medium which stores instructions executed by the processor 150. The memory 130 may include at least one of storage media such as a flash memory, a hard disk, a solid state disk (SSD), a random access memory (RAM), a static RAM (SRAM), a read only memory (ROM), a programmable ROM (PROM), an electrically erasable and programmable ROM (EEPROM), or an erasable and programmable ROM (EPROM).

The actuators 140 may control a behavior (e.g., acceleration, deceleration, braking, shift, and/or the like) of the vehicle under an instruction of the processor 150. The actuators 140 may include an acceleration actuator, a braking actuator, a shift actuator, a suspension actuator, and/or the like.

The processor 150 may be connected with the sensing device 110, the GPS receiver 120, the memory 130, and the actuators 140 and may control the overall operation of the autonomous driving control apparatus 100. The processor 150 may be implemented as at least one of processing devices such as an application specific integrated circuit (ASIC), a digital signal processor (DSP), a programmable logic device (PLD), a field programmable gate array (FPGA), a central processing unit (CPU), a microcontroller, or a microprocessor.

The processor 150 may set a destination depending on a user input received from a user interface (e.g., a touch screen, a microphone, a keyboard, and/or the like) or data input by an external electronic device. When the destination is set, the processor 150 may generate a driving path from a current position of the vehicle to the destination. At this time, when a starting point of the vehicle is also set, the processor 150 may generate a driving path from the current position of the vehicle to the starting point and may also generate a driving path from the starting point to the destination. The processor 150 may control the actuators 140 such that the vehicle performs autonomous driving along the driving path. In other words, the processor 150 may control a behavior of the vehicle under control of the actuators 140.

The processor 150 may recognize (or detect) an object which occupies the driving path of the vehicle using the sensing device 110 during autonomous driving. While the vehicle is traveling at an intersection along a predetermined driving path, the processor 150 may recognize an object located in an exit section of the intersection by means of the sensing device 110. While the vehicle is traveling in a right-turn section on the driving path of the vehicle, the processor 150 may recognize an object located immediately after the right-turn section using the sensing device 110.

The processor 150 may identify whether the recognized object meets a speed condition and/or a road occupancy condition. The processor 150 may determine whether the recognized object is a static object based on the identified result. In other words, the processor 150 may determine whether the recognized object is the static object based on a driving speed and a road occupancy state of the object.

When the recognized object meets the speed condition, the processor 150 may determine that the object is the static object. As an example, when the driving speed of the object recognized (or detected) by the sensing device 110 is less than or equal to a predetermined first reference speed (e.g., 1.8 km per hour (kph) or 5 kph), the processor 150 may determine that the object is the static object. As another example, when the driving speed of the recognized object is less than or equal to a predetermined second reference speed (e.g., 10.8 kph) and when the driving speed of the recognized object has been less than or equal to the first reference speed even once during a predetermined previous time (e.g., from 0.8 seconds ago to now), the processor 150 may determine that the object is the static object. The first reference speed may be different from the second reference speed and may be set to be less than the second reference speed.

When the recognized object meets the road occupancy condition, the processor 150 may determine that the object is the static object. As an example, when a distance between an outermost line on the right (or a road boundary line) of a road occupied by an object recognized based on the high-definition map DB and the recognized object is less than or equal to a predetermined reference distance (e.g., 0.3 m), the processor 150 may determine that the recognized object is the static object. At this time, an average speed of objects which are traveling on a lane next to a lane occupied by the static object should be greater than or equal to a predetermined third reference speed (e.g., 7.2 kph). As another example, when the recognized object crosses the outermost line on the right of the occupied road, the processor 150 may determine that the recognized object is the static object. As another example, when the recognized object is a 1-ton truck, a heavy truck, or a heavy bus, the processor 150 may determine that the recognized object is the static object only when the object crosses a right line of the occupied lane. As another example, when the object is not in a stop state when first recognizing the object, the processor 150 may determine that the object is the static object only when the recognized object meets both the speed condition and the road occupancy condition during a predetermined time (e.g., 7 seconds). For example, when a vehicle parked or stopped in an exit section on the intersection (or after a right-turn section) occupies the driving path of the vehicle, the processor 150 may determine the vehicle parked or stopped in the exit section of the intersection as the static object.

When it is determined that the object occupying the driving path of the vehicle is the static object, the processor 150 may select a drivable area. For example, when the vehicle parked or stopped in the exit section of the intersection is recognized, the processor 150 may determine the drivable area. The processor 150 may determine the drivable area based on the driving path of the vehicle, the current position of the vehicle, and the high-definition map DB.

Next, a description will be given of a method for selecting a drivable area with reference to FIG. 2.

The processor 150 may set a current position P_{ego} of a vehicle 210 as a start position of a path. The processor 150 may set (or calculate) a target merging position Pₜₐᵣ using road information (e.g., lane information, road boundary information, and the like) included in the high-definition map DB. The target merging position Pₜₐᵣ may be set to an end point of a lane adjacent to the left of a section where a static object 220 is located (i.e., a bounding box of the static object 220).

The processor 150 may determine a drivable area based on line information of a target merging lane, line information of a lane where the vehicle 210 is traveling, and information of the static object 220. The target merging lane may be set to a left lane adjacent to a lane where the static object 220 is located. The processor 150 may determine a left line of the target merging lane as a left boundary (or a first boundary) L1 of the drivable area. Furthermore, the processor 150 may determine a right line of the lane where the vehicle 210 is traveling as an initial left boundary (or a second boundary) L2₀ of the drivable area. The processor 150 may exclude an area of the static object 220 from the drivable area determined by the first boundary L1 and the initial second boundary L2₀ to finally determine the drivable area. In other words, the processor 150 may exclude the area of the static object 220 to correct the initial second boundary L2₀ of the drivable area to a second boundary L2.

The processor 150 may generate a driving path (or an autonomous driving path) based on the selected drivable area. To generate the driving path, the processor 150 may generate a reference path or a total reference path based on the selected drivable area. After succeeding in generating the reference path once, the processor 150 may not generate the reference path any longer. The processor 150 may extract an optimization target section from the generated reference path. The processor 150 may set a path after a control target point in the reference path to the optimization target section with regard to the speed of the vehicle. This is because vehicle steering fluctuates when the control target point changes depending on a real-time path change. The processor 150 may optimize a reference path in the set optimization target section. At this time, the processor 150 may optimize the reference path of the optimization target section using a quadratic programming (QP) optimization scheme.

The processor 150 may control a behavior of the vehicle such that the vehicle travels along the generated path. In other words, the processor 150 may control the actuators 140 to control a behavior of the vehicle.

The processor 150 may determine whether to stop driving for avoiding the static object. When the vehicle avoids the static object, the processor 150 may determine to end avoidance driving. When the vehicle does not complete avoidance of the static object, the processor 150 may repeat the path generation and driving process.

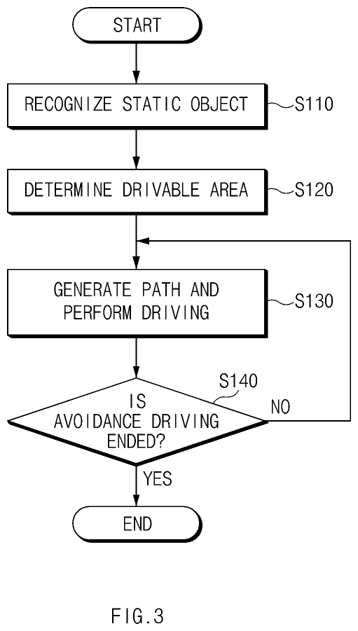

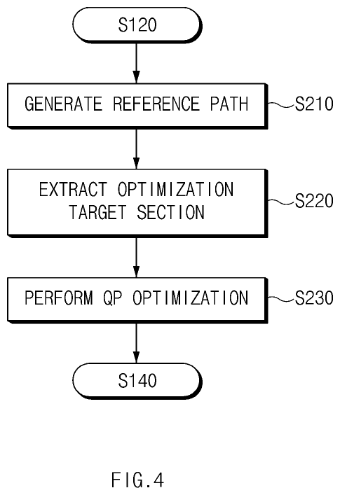

FIG. 3 is a flowchart illustrating an autonomous driving control method. The one or more example methods described herein with reference to, for example, FIGS. 3 and 4, may be performed by a host vehicle, a vehicle different from the host vehicle (e.g., another vehicle in proximity to the host vehicle), and/or a roadside unit (e.g., a roadside unit at the intersection).

Referring to FIG. 3, in S110, a processor 150 of an autonomous driving control apparatus 100 of FIG. 1 may recognize a static object on a driving path during autonomous driving. The processor 150 may recognize a vehicle parked or stopped in an exit section of an intersection (e.g., after a right-turn section) as the static object using a sensing device 110 of FIG. 1 while driving at the intersection.

When the static object is recognized, in S120, the processor 150 may determine a drivable area. The processor 150 may set a current position of the vehicle to a path start point and may set an end point of a left lane where the static object is located to a target merging position (or a target merging point). The processor 150 may select the drivable area with regard to a left line of a target merging lane, a right line of the driving lane of the vehicle, and an area occupied by the static object.

In S130, the processor 150 may generate a path based on the determined drivable area and may perform driving (or avoidance driving) along the generated path. The processor 150 may generate an avoidance path for avoiding the static object based on the determined drivable area. At this time, the processor 150 may generate a path (or an avoidance path) which does not intersect (or collide with) a boundary of the drivable area. The processor 150 may control actuators 140 of FIG. 1 to control a behavior of the vehicle such that the vehicle travels along the generated avoidance path.

In S140, the processor 150 may determine whether to stop driving for avoiding the static object. The processor 150 may identify whether the vehicle avoids the static object to determine whether to end avoidance driving depending to the identified result.

FIG. 4 is a flowchart illustrating a process of generating a path.

In S210, a processor 150 of an autonomous driving control apparatus 100 of FIG. 1 may generate a reference path in a drivable area.

In S220, the processor 150 may extract an optimization target section from the generated reference path. The processor 150 may set a reference path after a control target point to the optimization target section with regard to a speed of a vehicle.

In S230, the processor 150 may perform QP optimization of the reference path in the extracted optimization target section. QP may be to find a state value for minimizing an objective function in a state set meeting constraint functions. The objective function is convex quadratic, and a constraint is a convex optimization problem which is a linear equation. The QP may be represented in the following form.

### Quadratic Programming:

$$mini m {ize}_{x} ( \frac{1}{2} ) {z}^{T} Hz + {q}^{T} z$$

subject to lower bound b≤Az≤upper bound c

Herein, z denotes the n-dimensional vector (where there are n components), z^{T} denotes the transposed vector of vector z, H denotes the real symmetric matrix in n×n dimensions, q denotes the n-dimensional real vector, q^{T} denotes the transposed vector of vector q, A denotes the real vector in m×n dimensions, b denotes an m-dimensional real vector, and c denotes the m-dimensional real vector.

The constraint may be met, and cost may be optimized. The constraint may be represented as follows.

### Constraint:

### Initial State, End State:

p₀=[e_{y,0},e_{θ,0},k₀],p_{N}=[e_{y,N},e_{θ,N},k_{N}]^{T}

### Linearized Kinematic Vehicle Model:

pᵢ₊₁=Apᵢ+Buⱼ+cᵢ

### Path Lateral Offset:

e_{y,i}^{min}−εᵢ≤e_{y,i}^{max}+εᵢ

### Path Clearance:

$${d}_{i} = {e}_{y , i} - \frac{1}{2} ( {e}_{y , i}^{max} + {e}_{y , i}^{min} )$$

### Path Heading Offset:

e_{θ,min}≤e_{θ,i}≤e_{θ,max}

### Path Curvature:

−kₘₐₓ≤kᵢ≤kₘₐₓ

Herein, A, B, and c denote the linearized kinematic vehicle models, and e_{y}^{min} and e_{y}^{max} are the maximum N-axis direction values of the optimization path point.

A boundary condition is an initial state p₀ and an end state p_{N} for optimization. The vehicle model may be set to a constraint of a path state to generate a path capable of being physically followed by the vehicle. A maximum lateral offset of the path point may be limited to prevent a collision with a lateral drivable area boundary. The maximum lateral offset of the path point may be to generate a path where the vehicle is able to travel without a collision in a drivable area. The maximum lateral offset of the path point may be determined as a value obtained by subtracting half the vehicle width and a clearance for safety from a lateral distance to the drivable area boundary. The clearance for safety may be determined as being heuristic according to a vehicle size. A degree of deviation with respect to the center of a lane at the path point may be to maximize a distance to a lateral boundary of the drivable area on the path. A maximum heading error of the path point may limit that the optimization path generates a path too different from the reference path.

Path curvature may serve to limit maximum curvature of the path point to satisfy minimum turning radius restrictions.

The processor 150 may minimize the amount of change in curvature between paths using a cost function f to generate a smooth path u. The cost function f may be represented as Equation 1 below.

$$f = min {w}_{u} {\sum }_{j = 1}^{N - 1} {u}_{j}^{2} \qquad [ Equation 1 ]$$

Herein, u denotes the vehicle model input state, wᵤ denotes the weight of the vehicle model input state u, and N denotes the number of path points.

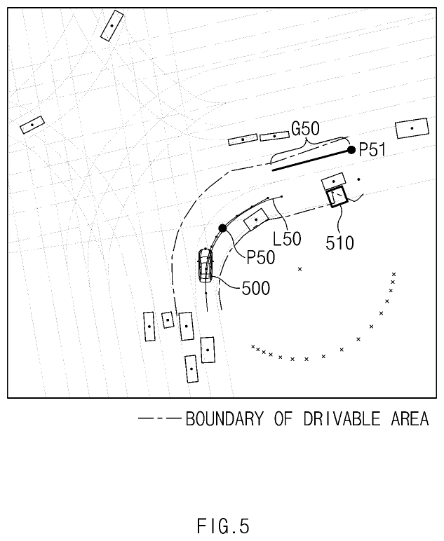

FIGS. 5 to 9 are drawings illustrating a process of generating a reference path.

Referring to FIG. 5, a processor 150 of FIG. 1 may search for a lateral control target point P50 on a current driving path L50 of a vehicle 500. At this time, the processor 150 may search for the lateral control target point P50 with regard to a current speed of the vehicle 500. For example, the processor 150 may determine a point where “the current speed of the vehicle×0.65” as the lateral control target point P50. This is to correct a path after the lateral control target point P50 when a current path of the vehicle 500 is corrected. When a path before the lateral control target point P50 is corrected, a steering angle of a steering wheel may be changed.

The processor 150 may determine (or calculate) an entry target lane section (or a target merging lane) G50 using the result of recognizing a static object and a high-definition map DB. The entry target lane section G50 is a lane next to a section where a static object 510 is located.

The processor 150 may determine a last point of the entry target lane section G50 as a path end point P51.

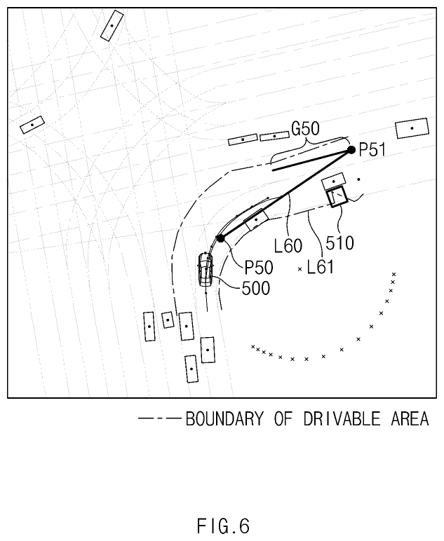

Referring to FIG. 6, the processor 150 may generate a straight line L60 connecting the lateral control target point P50 with the path end point P51.

The processor 150 may identify whether the generated straight line L60 collides with a boundary line L61 of a drivable area. In other words, the processor 150 may determine whether the straight line L60 connecting the lateral control target point P50 with the path end point P51 and the boundary line L61 of the drivable area intersect each other.

When the straight line L60 connecting the lateral control target point P50 with the path end point P51 and the boundary line L61 of the drivable area collide with (or intersect) each other, the processor 150 may move the path end point P51 by a predetermined distance (e.g., 1 cm) in the entry target lane section G50 and may repeat the movement of the path end point P51 by a predetermined number of times (e.g., 3 and 4 times) until finding a point where the straight line L60 and the boundary line L61 do not collide with each other.

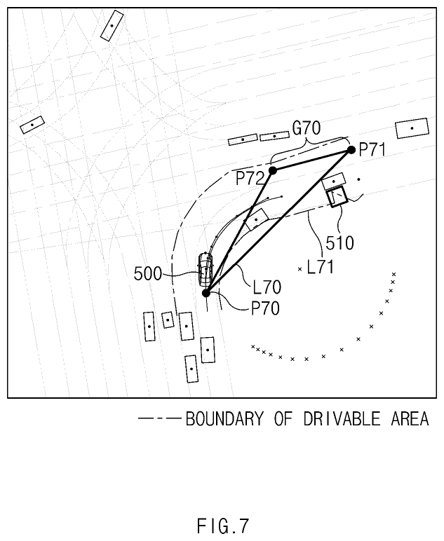

For example, as shown in FIG. 7, when a straight line L70 connecting a lateral control target point P70 with a path end point P71 collides with a right boundary line L71 of a drivable area, the processor 150 may move the path end point P71 by 1 m in the direction of a start point P72 of an entry target lane section G70 from the path end point P71 and may identify whether the straight line L70 connecting the lateral control target point P70 with the path end point P71 collides with the right boundary line L71 of the drivable area.

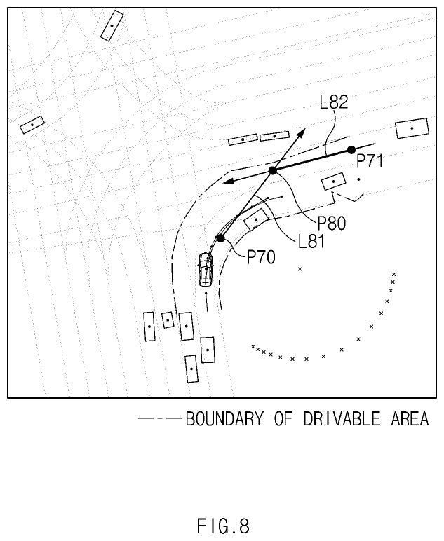

When the straight line L70 connecting the lateral control target point P70 with the path end point P71 does not collide with the right boundary line L71 of the drivable area, as shown in FIG. 8, the processor 150 may generate straight lines L81 and L82 considering a heading of each point at the lateral control target point P70 and the path end point P71. The processor 150 may calculate an intersection point P80 between the straight lines L81 and L82 considering the heading of each point.

The processor 150 may generate a quadratic Bezier curve using the lateral control target point P70, the intersection point P80, and the path end point P71. The processor 150 may use the generated quadratic Bezier curve as a reference path. In other words, the processor 150 may generate the reference path using the quadratic Bezier curve.

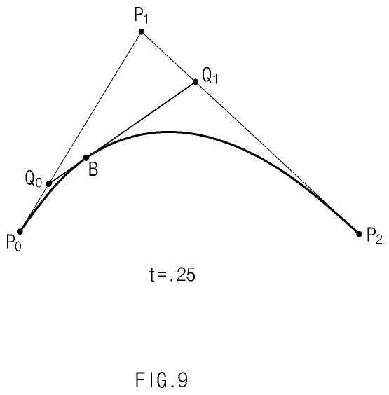

Referring to FIG. 9, when three points P₀, P₁, and P₂ are given, the quadratic Bezier curve is points where points on a line defined by P₀ and P₁ and points on a line defined by P₁ and P₂ are linearly Interpolated. The quadratic Bezier curve may be represented as Equation 2 below.

$$B ( t ) = {( 1 - t )}^{2} {P}_{0} + 2 ( 1 - t ) t {P}_{1} + {t}^{2} {P}_{2} \qquad [ Equation 2 ]$$

Herein, P₀ denotes the path generation start point, P₁ denotes the control point for controlling the shape of the Bezier curve, P₂ denotes the path generation end point, and 0≤t≤1. The Bezier curve always passes through two points P₀ and P₂.

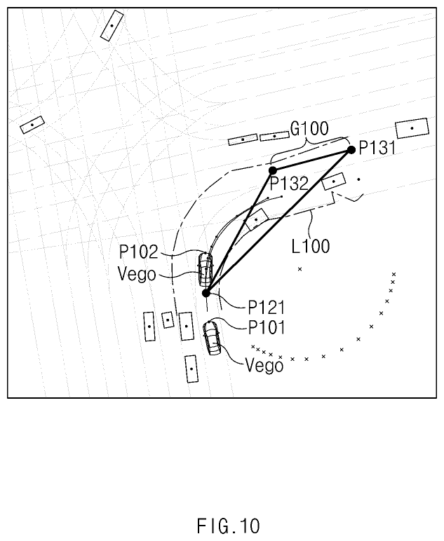

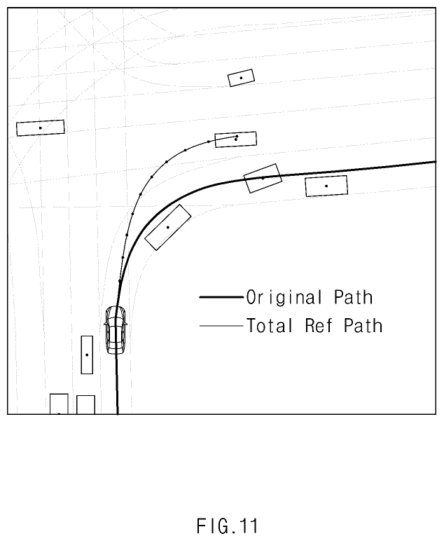

FIGS. 10 and 11 are drawings illustrating an example of generating a reference path.

Referring to FIG. 10, when a vehicle Vego is located at a first point P101, a straight line between both of points P131 and P132 in an entry target lane section G100 from a control target point P121 intersects a right boundary L100 of a drivable area. In this case, because there is no path capable of being generated, the vehicle Vego may travel along an existing right-turn path.

Thereafter, when the vehicle Vego arrives at a second point P102, because it is able to find a path end point which does not collide with the right boundary L100 of the drivable area, an autonomous driving control apparatus 100 of FIG. 1 may generate a reference path.

Referring to FIG. 11, when there is a vehicle parked or stopped on an existing right-turn path (or an original path), the autonomous driving control apparatus 100 may generate a reference path (or a total ref path) for generating a path capable of avoiding the parked or stopped vehicle. After succeeding in generating the reference path once, the autonomous driving control 100 may not generate the reference path any longer.

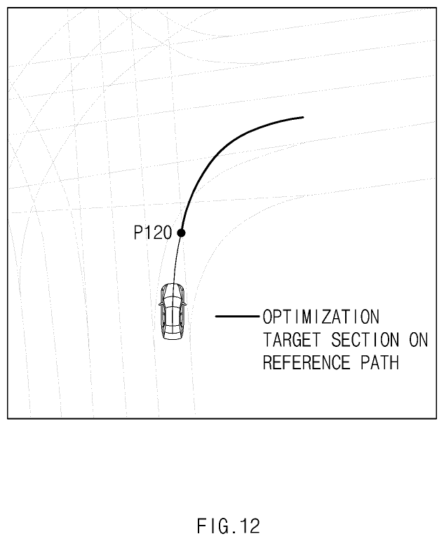

FIG. 12 is a drawing for describing a method for extracting an optimization target section.

When a reference path is generated, an autonomous driving control apparatus 100 of FIG. 1 may set an optimization target section on the generated reference path. The autonomous driving control 100 may extract a reference path after a control target point P120 as the optimization target section with regard to a speed of a vehicle. This is because vehicle steering fluctuates when the control target point P120 is changed according to a real-time path change.

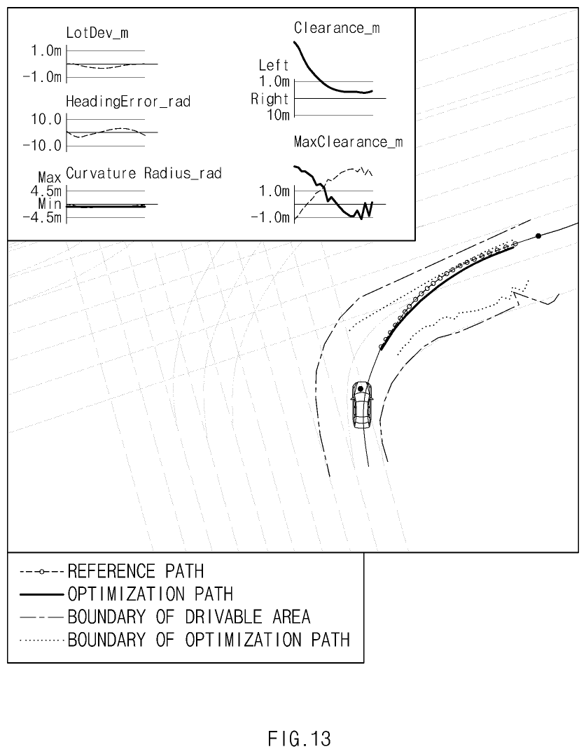

FIG. 13 is a drawing illustrating a QP optimization result.

An autonomous driving control apparatus 100 of FIG. 1 may optimize a reference path in an extracted optimization target section. At this time, the autonomous driving control 100 may optimize the reference path of the optimization target section using a quadratic programming (QP) optimization scheme.

The autonomous driving control 100 may optimize the reference path of the optimization target section with regard to a collision determination condition and a curvature limit condition. The collision determination condition is that an optimization path result should not deviate from a boundary of the optimization path. The boundary of the optimization path may refer to an area obtained by subtracting “(vehicle width/2)+margin 25%” from a boundary of a drivable area. The curvature limit condition is that a curvature radius for each optimization path point should be greater than a minimum turning radius. This is because of generating a path capable of being physically followed.

The autonomous driving control apparatus 100 may generate an optimization path meeting a curvature limit value without colliding with the boundary of the optimization path.

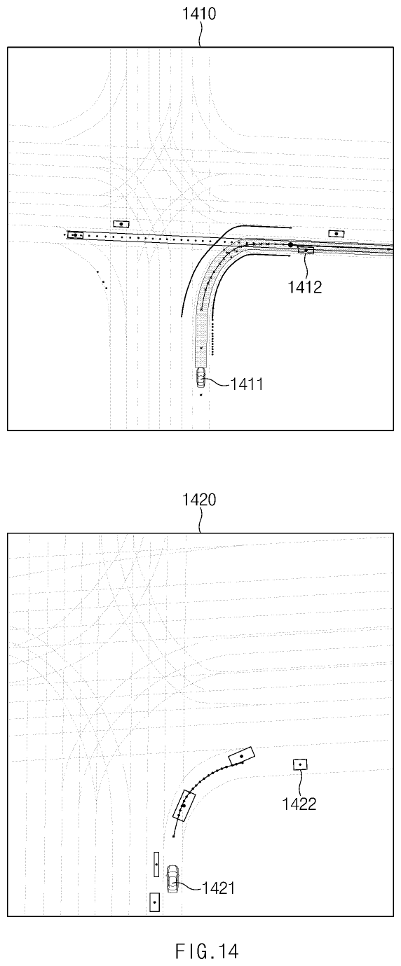

FIG. 14 is a drawing illustrating real-vehicle test and simulation results.

Referring to a simulation result 1410 of FIG. 14, when a vehicle 1412 is parked after a right-turn section in a situation where a vehicle 1411 travels in the right-turn section, an autonomous driving control apparatus 100 of FIG. 1 may generate a driving path such that the vehicle 1411 makes a right turn using a left lane of the parked vehicle 1412.

Referring to a real-vehicle test result 1420 of FIG. 14, because the autonomous driving control apparatus 100 provides an avoidance path using a left lane of a parked vehicle (i.e., a static object) 1422 such that a vehicle 1421 travels by avoiding the parked vehicle 1422 immediately after the vehicle 1421 makes a right turn in a situation where the vehicle 1421 makes a right turn at an intersection, it may allow the vehicle 1421 to naturally and efficiently travel on its behavior.

Embodiments of the present disclosure may plan a path such that a vehicle travels by avoiding a static object located on a driving path of the vehicle during autonomous driving.

Furthermore, embodiments of the present disclosure may plan a path to avoid a static object without executing a lane change function, when there is the static object in an exit section of the intersection during autonomous driving, thus naturally and efficiently controlling a behavior of the vehicle.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An autonomous driving control apparatus comprising:
a memory storing map data comprising road information;
a sensor configured to detect an object; and
a processor coupled to the memory and the sensor,
wherein the processor is configured to:
determine, using the sensor, a static object located in an exit section of an intersection associated with a vehicle;
determine, based on a location of the static object and the road information included in the map data, a drivable area;
determine, based on the drivable area, a driving path for the vehicle to avoid a collision with the static object; and
control a movement of the vehicle along the driving path.

2. The autonomous driving control apparatus of claim 1, wherein the processor is configured to determine the static object by determining, based on a moving speed of the object detected by the sensor and based on the road information, that the object detected by the sensor is the static object.

3. The autonomous driving control apparatus of claim 1, wherein the processor is configured to determine the drivable area by excluding the location of the static object from a lane on which the vehicle is traveling and from an adjacent lane that is next to the lane on which the vehicle is traveling.

4. The autonomous driving control apparatus of claim 1, wherein the processor is further configured to:
determine, in the drivable area, a reference path;
determine a portion of the reference path in an optimization target section; and
optimize the portion of the reference path in the optimization target section.

5. The autonomous driving control apparatus of claim 4, wherein the processor is further configured to:
determine a control target point on a current driving path of the vehicle;
determine, based on information about the static object and based on the map data, an entry target lane section;
determine whether a straight line connecting the control target point and one point of the entry target lane section intersects a boundary of the drivable area; and
based on a determination that the straight line does not intersect the boundary of the drivable area, determine an intersection point of straight lines that are generated based on headings at the control target point and the one point of the entry target lane section,
wherein the reference path is determined based on the control target point, the one point of the entry target lane section, and the intersection point.

6. The autonomous driving control apparatus of claim 4, wherein the processor is configured to determine the reference path based on a quadratic Bezier curve.

7. The autonomous driving control apparatus of claim 4, wherein the processor is configured to optimize the portion of the reference path in the optimization target section based on a quadratic programming optimization scheme.

8. The autonomous driving control apparatus of claim 4, wherein the processor is configured to optimize the portion of the reference path in the optimization target section based on a collision determination condition and a curvature limit condition.

9. The autonomous driving control apparatus of claim 8, wherein the collision determination condition is defined such that an optimization path does not deviate from a boundary of the optimization path.

10. The autonomous driving control apparatus of claim 8, wherein the curvature limit condition is defined such that a curvature radius for each optimization path point is greater than a minimum turning radius of the vehicle.

11. An autonomous driving control method comprising:
detecting, using a sensor, a static object located in an exit section of an intersection associated with a vehicle;
determining, based on a location of the static object and based on road information included in map data stored in a memory, a drivable area;
generating, based on the drivable area, a driving path for the vehicle to avoid a collision with the static object; and
controlling a movement of the vehicle along the driving path.

12. The autonomous driving control method of claim 11, wherein the detecting of the static object comprises:
determining, based on a moving speed of the object detected by the sensor and based on the road information, that the object detected by the sensor is the static object.

13. The autonomous driving control method of claim 11, wherein the determining of the drivable area comprises:
excluding the location of the static object from a lane on which the vehicle is traveling and from an adjacent lane that is next to the lane on which the vehicle is traveling.

14. The autonomous driving control method of claim 11, wherein the generating of the driving path comprises:
determining, in the drivable area, a reference path;
determining a portion of the reference path in an optimization target section; and
optimizing the portion of the reference path in the optimization target section.

15. The autonomous driving control method of claim 14, wherein the generating of the reference path comprises:
determining a control target point on a current driving path of the vehicle;
determining, based on information about the static object and further based on the map data, an entry target lane section;
determining whether a straight line connecting the control target point and one point of the entry target lane section intersects a boundary of the drivable area; and
based on a determination that the straight line does not intersect the boundary of the drivable area, determining an intersection point of straight lines that are generated based on headings at the control target point and the one point of the entry target lane section,
wherein the reference path is determined based on the control target point, the one point of the entry target lane section, and the intersection point.

16. The autonomous driving control method of claim 14, wherein the generating of the reference path comprises:
determining the reference path based on a quadratic Bezier curve.

17. The autonomous driving control method of claim 14, wherein the optimizing comprises:
optimizing the portion of the reference path in the optimization target section using a quadratic programming optimization scheme.

18. The autonomous driving control method of claim 14, wherein the optimizing comprises:
optimizing the portion of the reference path in the optimization target section based on a collision determination condition and a curvature limit condition.

19. The autonomous driving control method of claim 18, wherein the collision determination condition is defined such that an optimization path does not deviate from a boundary of the optimization path.

20. The autonomous driving control method of claim 18, wherein the curvature limit condition is defined such that a curvature radius for each optimization path point is greater than a minimum turning radius of the vehicle.
